(19) United States
(12) Patent Application Publication
(10) Pub. No.: US 2025/0022249 A1
(43) Pub. Date: Jan. 16, 2025

(54) IMAGE PROCESSING DEVICE, IMAGE PROCESSING SYSTEM, AND IMAGE PROCESSING METHOD

(71) Applicant: Hitachi Kokusai Electric Inc., Minato-ku, Tokyo (JP)

(72) Inventors: Keigo HASEGAWA, Tokyo (JP); Hiroto SASAO, Tokyo (JP)

(21) Appl. No.: 18/712,490

(22) PCT Filed: Dec. 7, 2021
(86) PCT No.: PCT/JP2021/044804

§ 371 Date: May 22, 2024

(51) Int. Cl. G06V 10/25; G06T 3/40; G06T 7/20; G06T 7/70

(52) U.S. Cl. CPC G06V 10/25; G06T 3/40; G06T 7/20; G06T 7/70; G06V 2201/07

(57) ABSTRACT

The present disclosure provides an image processing technique for performing high-speed tracking of a detection target in wide area monitoring. An image processing device includes a video acquisition unit to acquire a first image, an object detection processing unit to execute an object detection process on the first image, specify a target object therein, and generate a first object detection result indicating a position of the target object in the first image, a tracking processing unit to acquire a target region image including the target object, generate a resized image by executing a resizing process, execute an object detection process on the resized image, and generate a second object detection result indicating a position of the target object therein, and an integration processing unit to generate a final object detection result by integrating the first and second object detection results.

### TECHNICAL FIELD

The present invention relates to an image processing device, an image processing system, and an image processing method.

### Background Art

Heretofore, monitoring systems have been provided that use monitoring cameras capable of capturing images of suspicious objects and suspicious persons in various locations, such as in stores, on roads, and in parking lots, as part of crime prevention measures.

With regard to performing monitoring using cameras in a monitoring system with the aim of performing wide range monitoring, methods are known in which a camera having a PTZ (Pan-Tilt-Zoom) function is used to perform monitoring of the monitoring range cyclically, and when a monitoring target such as an intruder or an intruding vehicle is detected, the discovered object is followed.

Further, regarding systems that simultaneously capture and monitor a wide monitoring range, a method is provided in which, when intrusion is detected, the region in which intrusion was detected is expanded to follow the target. Specifically, as the resolution of cameras has increased in recent years, methods that use a camera capable of capturing wide-angle and high resolution images to first capture a wide area, and then expand the relevant range when intrusion is detected, are becoming more effective.

Methods for expanding the region in which intrusion is detected include digital zoom, in which a region specified by image processing is electronically expanded and displayed, and optical zoom, in which the region is optically expanded using a lens or the like and then displayed.

Further, recently, it is possible to distinguish intruding persons and vehicles using image analysis technology. Therefore, once intrusion is detected, it is possible to display the detected person or vehicle in an expanded manner and to automatically follow the movement thereof.

One example of a monitoring system is disclosed, for example, in Japanese Patent Laid-Open Publication No. 2019-124986 (Patent Document 1).

Patent Document 1 discloses a technique of “a failure detection system including an image capturing means (101) for capturing an image of a monitoring area on a road or the like with single or multiple angles of view, and an object extraction means (201) for extracting a range of an object occurring in the monitoring area and a pixel value from a video acquired by the image capturing means. The failure detection system further includes an object recognition means (202) for identifying a type of the object from a local feature amount by dividing the range of the object and the pixel value acquired by the object extraction means (201) into blocks based on the angle of view and a determination criterion set for each position in the video, and a failure detection means (204) for detecting the presence or absence of an obstacle in the video from information of the type of object acquired by the object recognition means (202).”

### CITATION LIST

### Patent Literature

### [Patent Document 1] Japanese Patent Application Laid-Open Publication No. 2019-124986

### SUMMARY OF INVENTION

### Problems to be Solved by the Invention

Patent Literature 1 discloses a technique for detecting an obstacle that has occurred within a predetermined monitoring area.

However, in the case of detecting and tracking a specific target object or event from a high-resolution image having a large size using the conventional means disclosed in Patent Literature 1, the amount of calculation required for processing increases. Therefore, when real-time processing is required, there is a need to use high performance computers, and the increase in the size of the devices or the increase in power consumption can become a problem. It may be possible to perform detection processes after reducing the image size in order to improve processing speed, but in that case, the size (number of pixels) of the detection target is reduced, which may cause target objects to be missed.

Furthermore, when performing enlarged display and tracking processing with respect to one specified detection target, monitoring of other regions cannot be performed, such that a plurality of detection targets cannot be monitored simultaneously according to the conventional technique disclosed in Patent Document 1.

Therefore, the present disclosure aims at providing an image processing technique capable of performing high speed and high precision tracking processing of the target object in wide area monitoring while suppressing the load of image processing.

### Means of Solving the Problems

In order to solve the problems mentioned above, one typical example of the present invention includes a video acquisition unit configured to acquire a first image; an object detection processing unit configured to execute a predetermined object detection processing with respect to the first image, specify a target object in the first image, and generate a first object detection result indicating a position of the target object in the first image; a tracking processing unit configured to acquire a target region image including the target object based on the first object detection result, generate a resized image by executing a resizing process of converting the target region image to a predetermined size, execute a predetermined object detection process with respect to the resized image, and generate a second object detection result indicating a position of the target object in the resized image; and an integration processing unit configured to generate a final object detection result by integrating the first object detection result and the second object detection result.

### Effects of Invention

According to the present disclosure, an image processing technique capable of performing high speed and high precision tracking processing of a target object in wide area monitoring while suppressing the load of image processing can be provided.

Problems, configurations and effects other than those described above will become apparent in the following description of embodiments.

### BRIEF DESCRIPTION OF DRAWINGS

FIG. 1 illustrates a computer system for carrying out the embodiments of a present disclosure.

FIG. 2 illustrates an example of a configuration of an image processing system according to a first embodiment of the present disclosure.

FIG. 3 is a flowchart illustrating the flow of an object detection process according to the first embodiment of the present disclosure.

FIG. 4 is a flowchart illustrating a tracking process according to the first embodiment of the present disclosure.

FIG. 5 is a flowchart illustrating the flow of an integration process according to the first embodiment of the present disclosure.

FIG. 6 is a flowchart illustrating the flow of a display control process according to the first embodiment of the present disclosure.

FIG. 7 is a view illustrating an example of a display screen according to the first embodiment of the present disclosure.

FIG. 8 illustrates an example of a configuration of an image processing system according to a second embodiment of the present disclosure.

FIG. 9 is a flowchart illustrating the flow of operation of the image processing system according to the second embodiment of the present disclosure.

### MODE FOR CARRYING OUT THE INVENTION

Hereafter, embodiments of the present invention will be described with reference to the drawings. The present embodiments are not intended to limit the scope of the present invention. In the drawings, the same parts are denoted with the same reference numbers.

In the following descriptions, there are cases where aspects of the present disclosure are described by specifying the embodiments, such as a first embodiment or a second embodiment, and there are other cases where aspects of the present disclosure are described without specifying a particular embodiment. The aspects of the present disclosure described by specifying an embodiment are not limited to the specified embodiment, and may be applied to other embodiments. Further, the aspects of the present disclosure described without specifying an embodiment may be applied to any of the embodiments, such as the first embodiment and the second embodiment.

As described above, in order to detect and track a specified target or event from a high-resolution image having a large size using conventional techniques, the amount of calculation required for detection processing increases. Therefore, in a case where real-time processing is required, a high-performance computer must be used, such that the increase in the size of the devices and the increase in power consumption can become a problem.

Therefore, according to the present disclosure, only the object detection processing is executed with respect to a high-resolution image, and the subsequent tracking process is executed with respect to an image having a lower resolution, such that high-speed and high precision tracking processing of a target object in wide area monitoring becomes possible, while suppressing the overall processing load.

Thereby, even in cases where real-time detection and tracking is required, such as in a state where the detection target is moved at a high speed, for example, a high-precision detection result may be provided in real time.

Further, by suppressing the processing load, it becomes possible to implement the image processing according to the embodiments of the present disclosure in a device having limited power, such as a drone.

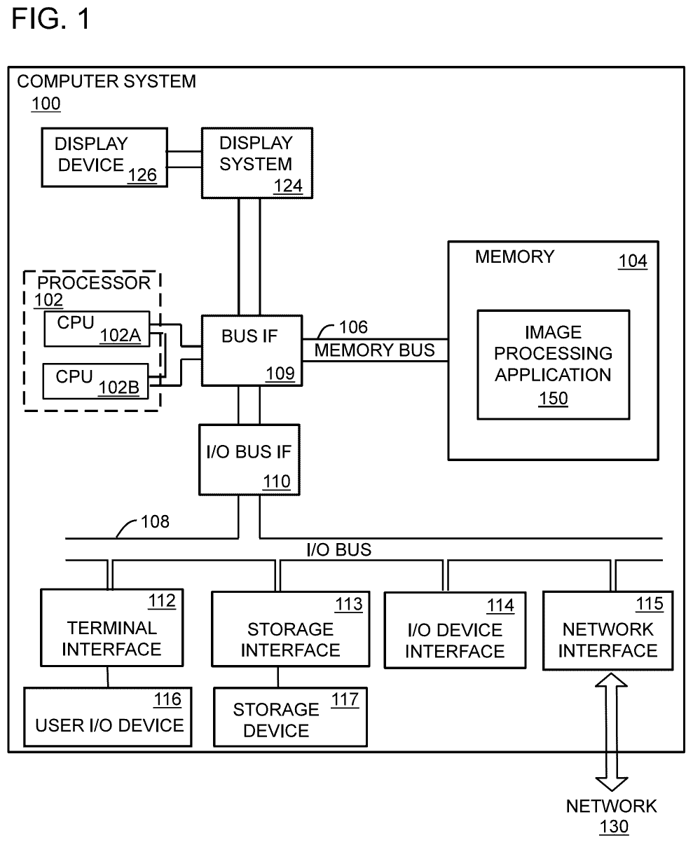

First, with reference to FIG. 1, a computer system 100 for implementing the embodiments of the present disclosure will be described. Various mechanisms and devices of the present embodiment disclosed in the present specification may be applied to an any appropriate computing system. The major components of the computer system 100 include a processor 102, a memory 104, a terminal interface 112, a storage interface 113, an I/O (input/output) device interface 114, and a network interface 115. These components may be mutually connected via a memory bus 106, an I/O bus 108, a bus interface unit 109, and an I/O bus interface unit 110.

The computer system 100 may include one or more general-purpose programmable central processing units (CPUs) 102A and 102B that are collectively referred to as the processor 102. In embodiments, the computer system 100 may be equipped with a plurality of processors, and in a different embodiment, the computer system 100 may be a single CPU system. The respective processors 102 execute commands stored in the memory 104, and may include an on-board cache. Further, the processor 102 may be equipped with a processor capable of performing high-speed arithmetic processing, such as GPU, FPGA, DSP, and ASIC.

According embodiments, the memory 104 may include a random-access semiconductor memory, a storage device, or a storage medium (either volatile or nonvolatile) for storing data and programs. The memory 104 may store all or a portion of the programs, modules, and data structures for executing the functions described in the present specification. For example, the memory 104 may store an image processing application 150. In a certain embodiment, the image processing application 150 may include a command or a description for executing the functions described below on the processor 102.

According embodiments, instead of the processor-based system, or in addition to the processor-based system, the image processing application 150 may be implemented on a hardware via a semiconductor device, a chip, a logic gate, a circuit, a circuit card, and/or other physical hardware devices. According embodiments, the image processing application 150 may include data other than instructions or statements. In embodiments, a camera, a sensor, or other data input devices (not shown) may be provided in direct communication with the bus interface unit 109, the processor 102, or other hardware of the computer system 100.

The computer system 100 may include a bus interface unit 109 that realizes communication of the processor 102, the memory 104, a display system 124, and the I/O bus interface unit 110. The I/O bus interface unit 110 may be connected to the I/O bus 108 for transferring data with various I/O units. The I/O bus interface unit 110 may communicate via the I/O bus 108 with a plurality of I/O interface units 112, 113, 114, and 115 also known as I/O processors (IOP) or I/O adapters (IOA).

The display system 124 may include a display controller, a display memory, or both. The display controller may provide video, audio, or both video and audio data to the display device 126. Further, the computer system 100 may include devices such as one or more sensors configured to collect data and provide the data to the processor 102.

For example, the computer system 100 may include a biometric sensor for collecting heart rate data and stress level data, an environmental sensor for collecting humidity data, temperature data, pressure data and the like, and a motion sensor for collecting acceleration data, motion data and the like. Other types of sensors may also be used. The display system 124 may be connected to the display device 126 such as an independent display screen, a television, a tablet, or a mobile device.

The I/O interface unit is provided with a function for communicating with various storages and I/O devices. For example, a terminal interface unit 112 enables attachment of a user output device such as a video display device, a speaker, a television, or a user input device such as a keyboard, a mouse, a keypad, a touchpad, a trackball, a button, a light pen, or other pointing device. The user may enter input data and commands to the user I/O device 116 and the computer system 100 by operating the user input device through the user interface, and may receive output data from the computer system 100. The user interface may be displayed on a display device, played on a speaker, or printed using a printer, via the user I/O device 116.

The storage interface 113 may enable attachment of one or a plurality of disk drives or a direct access storage device 117 (which is normally a magnetic disk drive storage device, but may also be a disk driver array that are configured to be recognized as a single disk drive, or other storage devices). According to embodiments, the storage device 117 may be implemented as an any type of secondary storage device. The contents of the memory 104 are stored in the storage device 117, and may be read out from the storage device 117 as necessary. The I/O device interface 114 may provide an interface to other I/O devices, such as a printer or a facsimile machine. The network interface 115 may provide a communication path that allows the computer system 100 to communicate mutually with other devices. The communication path may be a network 130, for example.

According to embodiments, the computer system 100 may be a device that has no direct user interface and that receives requests from other computer systems (clients), such as a multi-user main frame computer system, a single user system, or a server computer. According to other embodiments, the computer system 100 may be a desktop computer, a portable computer, a note personal computer, a tablet computer, a pocket computer, a telephone, a smartphone, or other arbitrary appropriate electronic devices.

### First Embodiment

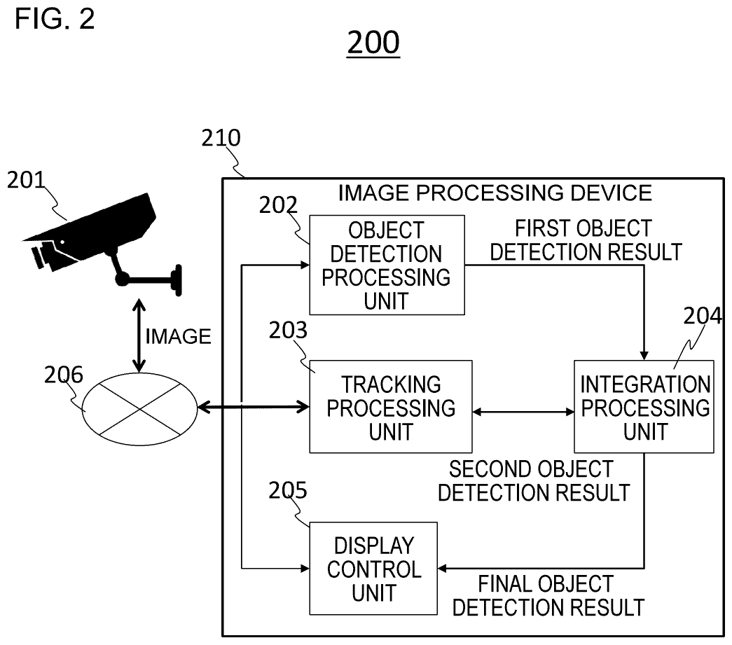

Next, a configuration of an image processing system according to a first embodiment of the present disclosure will be described with reference to FIG. 2.

FIG. 2 is a view illustrating one example of a configuration of an image processing system 200 according to a first embodiment of the present disclosure. The image processing system 200 according to the first embodiment of the present disclosure is a system for performing high-speed tracking processing of a target object in wide area monitoring, and as illustrated in FIG. 2, is mainly composed of a video acquisition device 201 and an image processing device 210. The video acquisition device 201 and the image processing device 210 are connected in a mutually communicable manner via a communication network 206, such as the Internet.

The video acquisition device 201 is a functional unit configured to capture an image of a predetermined environment and acquire video data showing the environment. The video acquisition device 201 may be a normal camera having a fixed angle of view, or may be a camera having an adjustment function such as pan, tilt, and zoom, or a swiveling camera capable of rotating 360 degrees. The video acquisition device 201 may be installed in advance at a location capable of capturing the image of the predetermined environment, or may be mounted on a moving body such as a drone, as described below.

The video data acquired by the video acquisition device 201 is an image sequence that is composed of a plurality of successive image frames. Further, the video data may be a high-resolution video. Herein, the term “high-resolution” image refers to an image that satisfies a first pixel count criterion. The first pixel count criterion is a threshold value that designates a specified lower limit of the number of pixels, and may be a number of pixels greater than or equal to 1920 pixels×1080 pixels (FHD), a number of pixels greater than or equal to 4K (4096 pixels×2160 pixels or 3840 pixels×2160 pixels), or a number of pixels greater than or equal to 8K (7680 pixels×4320 pixels), for example.

The installation location and the number of the video acquisition devices 201 are not particularly specified in the present disclosure, and may be determined arbitrarily according to the object of monitoring and the like. Further, in the present description, an example is illustrated in which the video acquisition device 201 is a device that is connected to the image processing device 210 via the communication network 206, but the present disclosure is not limited thereto, and the video acquisition device 201 may be implemented as an image processing unit within the image processing device 210.

The image processing device 210 is a device for receiving the video data acquired by the video acquisition device 201 via the communication network, and thereafter, executing an image processing technique according to the embodiment of the present disclosure. As illustrated in FIG. 2, the image processing device 210 includes an object detection processing unit 202, a tracking processing unit 203, an integration processing unit 204, and a display control unit 205.

The object detection processing unit 202 is a function unit that executes a predetermined object detection process with respect to a specific image frame (hereinafter referred to as a “first image”) in video data acquired by the video acquisition device 201, to thereby specify a target object in the first image and generate a first object detection result at least indicating a position of the target object in the image.

If the first image is an image frame from high-resolution video data, naturally, the first image will be a high-resolution image, similarly to the video data. In general, the speed of object detection processing becomes slower as the image resolution becomes higher, but according to the present disclosure, the object detection processing may be able to process video data at a speed of approximately 1 to 3 FPS.

The details of the processing performed by the object detection processing unit 202 will be described below, so a description thereof will be omitted here.

The target object described in the present description refers to an object that is to be detected in the image. The target object may be set arbitrarily by an administrator of the image processing system 200 when setting the object detection processing, for example. As an example, the target object according to the present example may be a person having a predetermined feature (a woman wearing a red hat, a man holding a gun), an animal, an automobile, a building, or another arbitrary object.

The tracking processing unit 203 acquires a target region image including a detected target object based on the first object detection result generated by the object detection processing unit 202, and executes a resizing process to convert the target region image into a predetermined size, to thereby generate a resized image. The tracking processing unit 203 is a functional unit that executes a predetermined object detection process with respect to the resized image thereafter, and generates a second object detection result that indicates at least a position of the target object in the image.

The resized image mentioned here is an image smaller than a second pixel count criterion. The second pixel count criterion is a threshold value that designates a specified upper limit of the number of pixels, and may be a number of pixels less than or equal to 1920 pixels×1080 pixels (FHD), a number of pixels less than or equal to 640 pixels×480 pixels, a number of pixels less than or equal to 320 pixels×240 pixels, or 50% less pixels than the first image, for example.

As described, the resized image will be an image having a lower resolution compared to the first image. Therefore, compared to the object detection processing performed with respect to the first image by the object detection processing unit 202, the object detection processing performed with respect to the resized image by the tracking processing unit 203 will have a lower processing load, and may be performed at high speed (such as 10 FPS or higher).

The processing performed by the tracking processing unit 203 will be described in detail later, so that the description thereof will be omitted here.

The target region image mentioned above is the image acquired around the target object detected by the object detection processing unit 202. According to one aspect of the present disclosure, the tracking processing unit 203 may extract the target region image by cropping the first image based on the first object detection result.

According to another aspect of the present disclosure, the tracking processing unit 203 determines image capturing conditions (such as the pan, tilt, and zoom settings for capturing a clear image of the target object near the center of the image) for capturing a target region image including the target object based on the first object detection result, and transmits the determined image capturing conditions to the video acquisition device 201. Thereafter, the video acquisition device 201 transmits the image acquired by performing the image capturing based on these image capturing conditions as the target region image to the tracking processing unit. Thereby, the target region image may be acquired without performing any processing to the first image.

The integration processing unit 204 is a functional unit that generates a final object detection result by integrating the first object detection result from the object detection processing unit 202 and the second object detection result from the tracking processing unit 203. The final object detection result described here is information acquired by integrating the first object detection result and the second object detection result, such that it indicates the position of the target object more accurately compared to the first object detection result and the second object detection result.

For example, in this stage, the integration processing unit 204 may use the first object detection result and the second object detection result to execute a so-called Intersection Over Union (IoU) processing to generate a final object detection result that indicates an estimated position of the target object.

The processing according to the integration processing unit 204 will be described later, so that the description thereof will be omitted here.

The display control unit 205 is a functional unit for displaying the final object detection result generated by the integration processing unit 204.

The processing by the display control unit 205 will be described in detail later, so that the description thereof will be omitted here.

The various function units included in the image processing device 210 described above may be implemented as a software module of the image processing application 150 stored in the memory of the computer system 100 illustrated in FIG. 1, for example.

Meanwhile, various functional units included in the image processing device 210 may be implemented on a different computer. In such a case, as the object detection processing unit 202 may be an image analysis unit that performs detection of the target object in an image having a large size, such as 4K or FHD, the object detection processing unit 202 is preferably implemented in a computer having a higher performance than that of the tracking processing unit. As an example, a configuration may be provided in which the object detection processing unit 202 is implemented in a high-performance computer on a cloud and the tracking processing unit is implemented in a moving body such as a drone.

According to the image processing system 200 described above, by executing only the object detection processing with respect to the high-resolution image (first image) and executing the subsequent tracking processing with respect to an image having a lower resolution (a resized image), high-speed and high-precision tracking processing of a target object in wide area monitoring can be enabled while suppressing the load of the image processing.

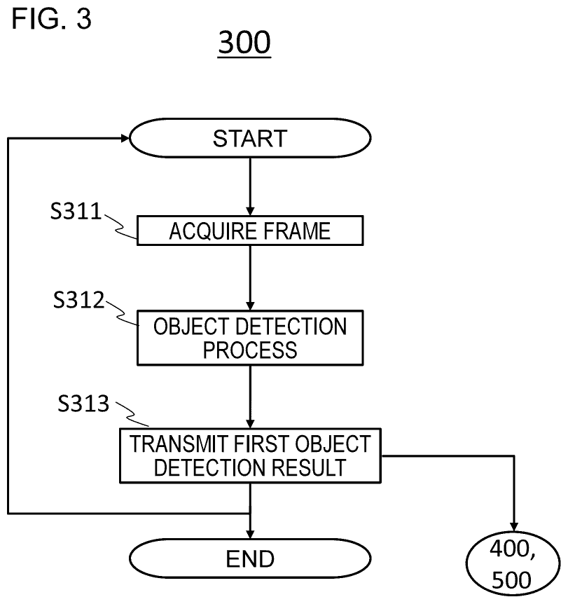

Next, with reference to FIG. 3, the object detection processing according to the first embodiment of the present disclosure will be described.

FIG. 3 is a flowchart illustrating the flow of an object detection process 300 according to the first embodiment of the present disclosure. The object detection process 300 illustrated in FIG. 3 is a process for determining the target object in a high-resolution image, which is executed by the object detection processing unit 202 illustrated in FIG. 2, for example.

At first, in step S311, the object detection processing unit 202 acquires a specific image frame (hereinafter referred to as a “first image”) from the video data acquired by the video acquisition device 201. Here, the object detection processing unit 202 may acquire the first frame in the video data transmitted in real time from the video acquisition device 201 as the first image.

Next, in step 312, the object detection processing unit 202 executes a predetermined object detection process with respect to the first image acquired in step S311. The object detection processing described here may include any existing object detection processing techniques, such as Viola-Jones object detection framework based on Haar features, Scale-Invariant Feature Transform (SIFT), Histogram of Oriented Gradients (HOG), Region-based Convolutional Neural Network (R-CNN), Fast R-CNN, Faster R-CNN, Cascade R-CNN, Single Shot Multi-Box Detector (SSD), You Only Look Once (YOLO), Single-Shot Refinement Neural Network for Object Detection (RefineDet), Retina-Net, and Deformable convolutional networks.

As described above, the object detection process executed here is performed with respect to the high-resolution image, such that it is executed at a low speed with respect to the frame rate of the video acquisition device 201, but since a wide range is captured, the target object will not be overlooked.

By executing the object detection process, the object detection processing unit 202 can generate, for the first image, a first object detection result indicating the position of each detected target object in the image and the class of the target object.

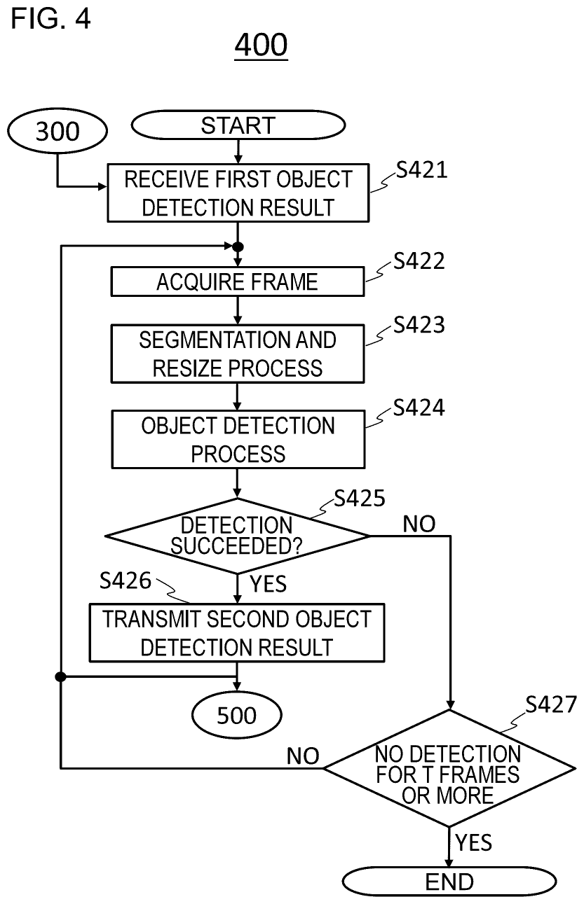

Next, in step S313, the object detection processing unit 202 transmits the first object detection result generated in step S312 to the tracking processing unit 203 and the integration processing unit 204 described above. Thereafter, the tracking process 400 illustrated in FIG. 4 is initiated.

After the processing of the first image has ended, the present processing returns to step S311, and processing of a subsequent image frame of the video data (that is, the image frame subsequent to the first image frame) is initiated. As described, the respective frames of the video data are sequentially processed, and object detection results with respect to the respective frames are generated.

Next, a tracking process according to the first embodiment of the present disclosure will be described with reference to FIG. 4.

FIG. 4 is a flowchart illustrating the flow of the tracking process 400 according to the first embodiment of the present disclosure. The tracking process 400 illustrated in FIG. 4 is a process for tracking the target object, and it is executed by the tracking processing unit 203 illustrated in FIG. 2, for example.

At first, in step S421, the tracking processing unit 203 begins the tracking processing when a first object detection result is received from the object detection processing unit.

In the first object detection result, when a plurality of target objects are specified, the tracking processing unit 203 begins the tracking process for each of the identified target objects. However, for convenience of description, a tracking process performed with respect to one target object will be described here.

Next, in step S422, the tracking processing unit 203 acquires an image frame in which the target object is identified (hereinafter referred to as “first image”) based on the first object detection result.

Next, in step S423, the tracking processing unit 203 determines a target region including the target object based on the first object detection result, and acquires an image of the target region. In the present description, the term target region refers to a region in the image that at least illustrates the target object. Further, the target region may preferably be set greater than the size of the target object. For example, the target region may preferably be three times or more larger than the target object in both the vertical and horizontal directions.

According to one aspect of the present disclosure, the tracking processing unit 203 may extract the target region image by cropping it out from the first image based on the coordinates of the target object in the image indicated in the first object detection result.

Further, according to another aspect of the present disclosure, the tracking processing unit 203 may determine image capturing conditions (such as the pan, tilt, and zoom settings for capturing a clear image of the target object near the center of the image) for capturing a target region image including the target object based on the first object detection result, and transmit the determined image capturing conditions to the video acquisition device 201. Thereafter, the video acquisition device 201 transmits the image acquired by capturing the image based on the image capturing conditions as the target region image to the tracking processing unit. Thereby, the target region image may be acquired without performing any processing with respect to the first image.

After acquiring the target region image, the tracking processing unit 203 performs a resizing process for converting the acquired target region image to a predetermined size, and generates a resized image. Here, the tracking processing unit 203 nay perform the resizing process by expanding or reducing the target region image. Further, the size of the resized image is not specifically limited, and it may be set arbitrarily considering the precision and speed of the object detection processing. As an example, the tracking processing unit 203 may resize the target region image into Video Graphics Array (VGA: 640 pixels×480 pixels) or Quarter Video Graphics Array (QVGA: 320 pixels×240).

As described in the present disclosure, by converting the target region image to a resized image having a lower resolution, the load of the tracking processing may be suppressed, and the processing time may be shortened.

Next, in step S424, the tracking processing unit 203 executes a predetermined object detection process with respect to the resized image generated in step S423. The object detection process described here may be similar to the object detection processing utilized in the object detection process 300 described above, or may be a different object detection process.

For example, the tracking processing unit 203 may perform object tracking by performing feature point matching among frames (frames before and after the first image) using a Kanade-Lucas-Tomasi (KLT) tracker or the like. A new feature point may be extracted from within the region of the object, and tracking is performed until a tracking end condition, such as vanishing or stopping of the feature point, is satisfied. By performing such an object tracking process, the trajectory of the respective feature points moving within the screen may be obtained. By performing clustering of the trajectory of each feature point based on the information such as the position, the direction of movement, and the region of the object from which the feature point was obtained, a plurality of clusters indicating the movement of the objects moving in the video may be acquired.

As described, the resized image is an image having a lower resolution compared to the first image. Therefore, compared to the object detection process performed with respect to the first image in the object detection process 300, the object detection process performed with respect to the resized image in the tracking processing 400 has a smaller processing load and can be performed at a high speed.

As described, by performing object detection processing with respect to the resized image, the tracking processing unit 203 can generate a second object detection result indicating the position (the coordinates in the image) of each detected target object in the image and the class of the target object.

Next, in step S425, the tracking processing unit 203 determines whether the target object has been detected by the object detection process. If the target object has been detected, the present processing advances to step S426. Conversely, if the target object has not been detected, the processing advances to step S427.

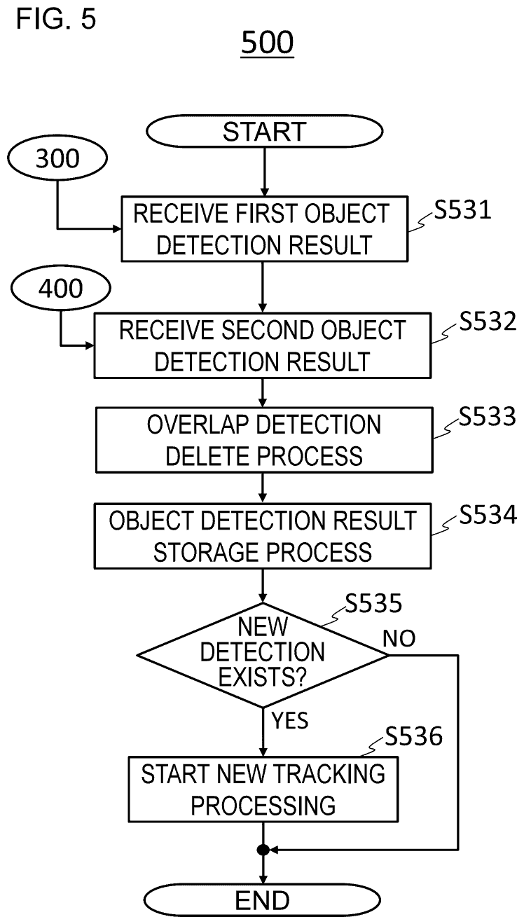

Next, in step S426, the tracking processing unit 203 transmits the second object detection result generated in step S424 to the integration processing unit 204 described above. Thereafter, the integration process 500 illustrated in FIG. 5 is started, and the process returns to step S422, where processing for the next image frame in the video data is begun.

Next, in step S427, the tracking processing unit 203 determines whether the number of frames in which the target object has not been detected is equal to or greater than a predetermined number T. If the number of frames in which the target object has not been detected is equal to or greater than the predetermined number “T”, the tracking processing unit 203 recognizes that the target object has been lost, and the present processing is ended. Meanwhile, if the number of frames in which the target object has not been detected is less than the predetermined number “T”, the present processing returns to step S422, and the processing of the subsequent image frame in the video data is begun.

Next, with reference to FIG. 5, an integration process according to the first embodiment of the present disclosure will be described.

FIG. 5 is a flowchart illustrating a flow of the integration process 500 according to the first embodiment of the present disclosure. The integration process 500 illustrated in FIG. 5 is a process for integrating the first object detection result generated by the object detection process 300 and the second object detection result generated by the tracking process 400, and for example, can be is executed by the integration processing unit 204 illustrated in FIG. 2.

As described above, according to the object detection process 300 and the tracking process 400, two object detection results indicating the position of the target object can be obtained. However, the position of the target object in the image may deviate between the first object detection result and the second object detection result. Therefore, according to the integration process 500 illustrated in FIG. 5, the first object detection result and the second object detection result are integrated as one, such that a final object detection result that illustrates the position of the target object in the image more reliably may be obtained.

First, in step S531, the integration processing unit 204 receives the first object detection result from the object detection processing unit 202.

Next, in step S532, the integration processing unit 204 receives the second object detection result from the tracking processing unit 203.

Next, in step S533, the integration processing unit 204 aligns and overlaps the first object detection result and the second object detection result, and determines whether the positions of the target objects within the image overlap.

If the regions of the target objects in the first object detection result and the second object detection result mutually overlap, the integration processing unit 204 uses an Intersection Over Union (IoU), for example, to determine the position of the target object based on an overlap degree of the detected target object regions or a predetermined threshold value of IoU, and integrates the first object detection result and the second object detection result to thereby generate a final object detection result.

Meanwhile, if the regions of the target objects in the first object detection result and the second object detection result do not mutually overlap, the integration processing unit 204 may utilize both the first object detection result and the second object detection result as the final object detection result.

Next, in step S534, the integration processing unit 204 stores an image frame number in the video data, a target object position, a target object class, and a target object detection ID as the final object detection result generated in step S533 to a predetermined storage region.

Next, in step S535, if it is determined by the integration processing unit 204 that a new detection exists (that is, if the target object position, the target object class, or the target object detection ID of the final object detection result generated in step S533 differ from those of the final object detection result stored previously) regarding the final object detection result generated in step S533, the present processing advances to step S536, and a new tracking processing is started. If it is determined that a new detection does not exist, the present processing is ended.

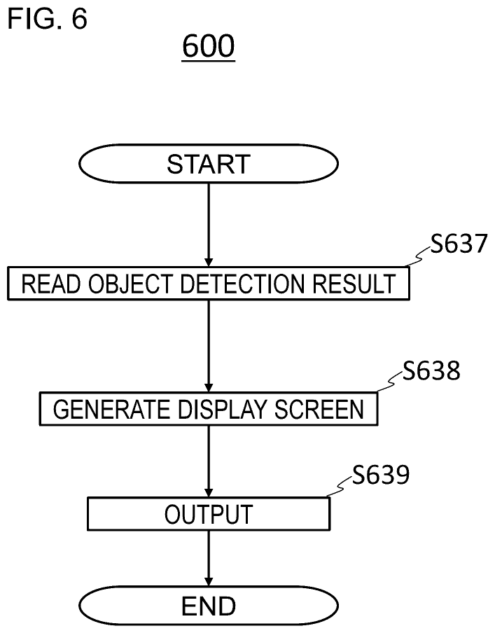

Next, with reference to FIG. 6, a display control processing according to the first embodiment of the present disclosure will be described.

FIG. 6 is a flowchart illustrating a flow of a display control process 600 according to the first embodiment of the present disclosure. The display control process 600 illustrated in FIG. 6 is a process for displaying the final object detection result generated by the integration processing unit 204, and is executed by the display control unit 205 illustrated in FIG. 2, for example.

At first, in step S637, the display control unit 205 acquires the newest final object detection result from among the final object detection results stored in the storage range in the integration processing 500 described above.

Next, in step S638, the display control unit 205 generates a display screen for displaying the final object detection result acquired in step S637.

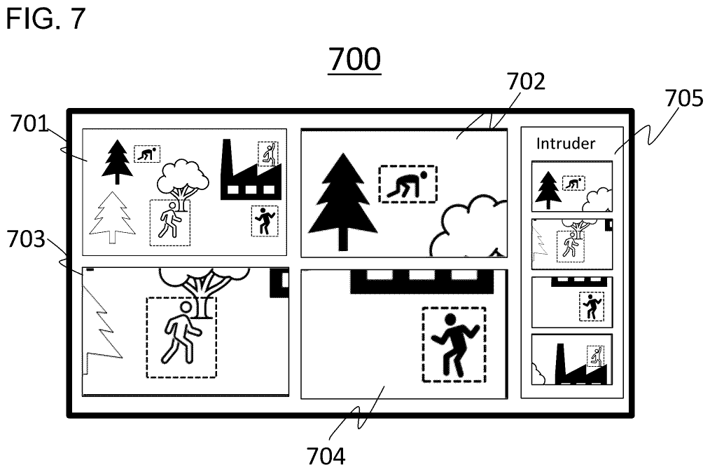

One example of the display screen is illustrated in FIG. 7, such that the description thereof will be omitted here.

Next, in step S639, the display control unit 205 outputs the display screen generated in step S638 to a predetermined display device (such as the display of a computer, or the screen of a smartphone or a tablet terminal).

Next, with reference to FIG. 7, a display screen according to the first embodiment of the present disclosure will be described.

FIG. 7 is a view illustrating one example of a display screen 700 according to the first embodiment of the present disclosure. As described above, the display screen 700 is a screen for displaying the final object detection result generated by the image processing device according to the first embodiment of the present disclosure.

More specifically, as illustrated in FIG. 7, the display control unit 205 generates, based on the final object detection result generated by the integration processing unit 204, an image 701 in which a rectangle is overlapped on each of the positions where a target object was detected, and images 702, 703, and 704 illustrating an enlarged view of the regions around the areas where the target objects were detected and in which rectangles are overlapped on each of the target object positions, and displays the generated images as tile displays on the display screen 700.

Further, if there are many target objects to be detected, the display control unit 205 may display a reduced thumbnail image 705 at the edge of the display screen 700 for a target object other than the target objects shown in the images 701 to 704. By selecting the thumbnail image 705, the user may replace the selected thumbnail image 705 with any one of the images 701 to 704.

As described, according to the image processing technique of the first embodiment of the present disclosure, by executing the object detection processing with respect to only the high-resolution image (first image), and executing the tracking processing performed thereafter with respect to an image (the resized image) having a lower resolution, high-speed and high-precision tracking processing of a target object in wide area monitoring is enabled while the load of image processing is suppressed.

### Second Embodiment

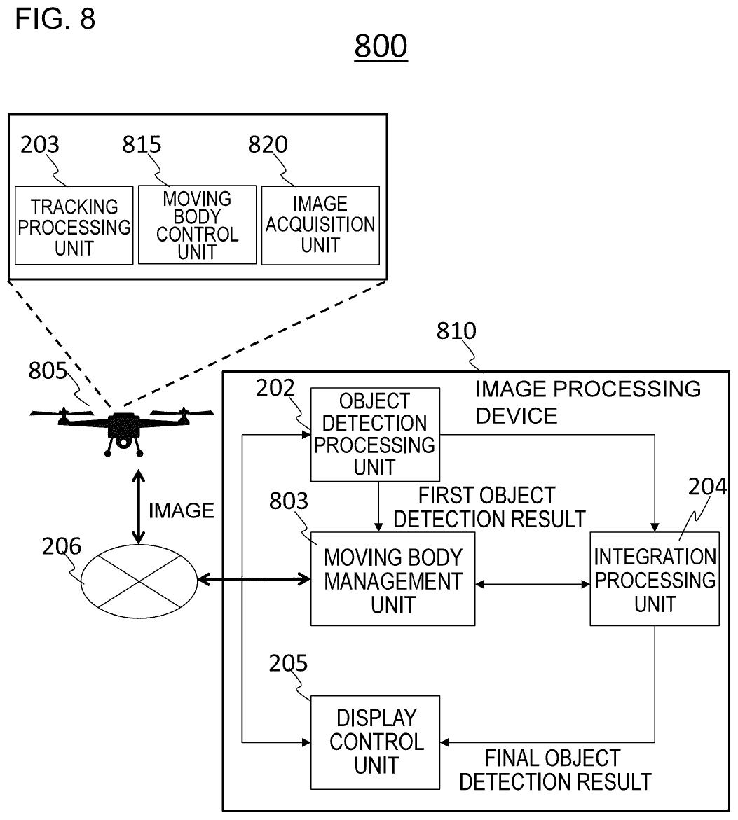

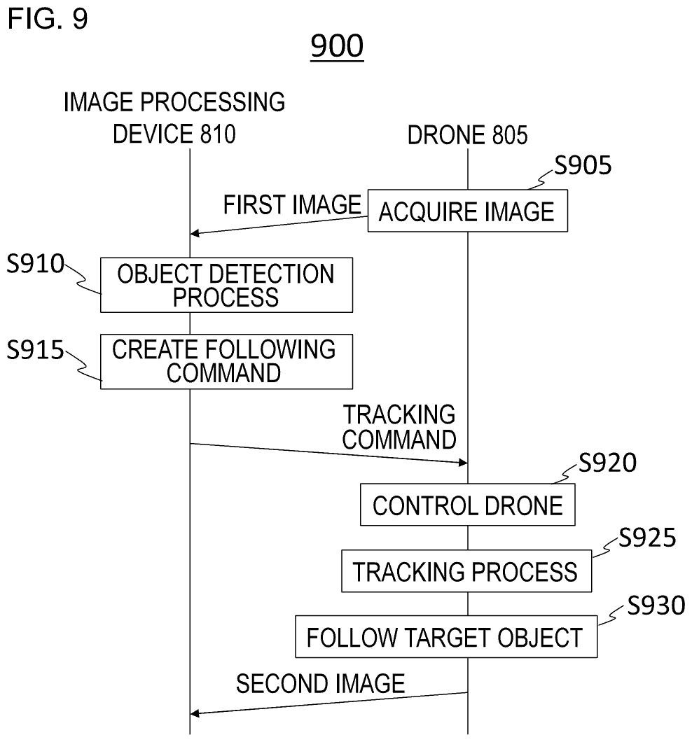

Next, with reference to FIGS. 8 and 9, an image processing system according to a second embodiment of the present disclosure will be described.

According to the first embodiment described above, an example has been described in which a monitoring camera or the like installed at a specified location is used as the video acquisition device 201 of the present disclosure, but the present disclosure is not limited thereto, and a configuration in which the video acquisition device 201 is installed on a moving body such as a drone is also possible. Therefore, according to the second embodiment of the present disclosure, an image processing system 800 in which the video acquisition device 201 is mounted on a drone and a portion of the image processing is executed on the drone side will be described. However, the present disclosure is not limited to drones, and the video acquisition device 201 may be mounted on a robot or on an automobile driven by a person.

FIG. 8 is a view illustrating one example of a configuration of the image processing system 800 according to the second embodiment of the present disclosure. The configuration of the image processing system 800 illustrated in FIG. 8 is substantially similar to the configuration of the image processing system 200 according to the first embodiment, such that for convenience of description, a redundant description of shared parts will be omitted, and the differences between the second embodiment and the first embodiment will mainly be described.

The image processing system 800 according to the second embodiment of the present disclosure is a system for performing high-speed tracking processing of a target object in wide area monitoring, and primarily includes a drone 805 and an image processing device 810, as illustrated in FIG. 8. The drone 805 and the image processing device 810 are mutually connected by wireless communication through a communication network 206, such as the Internet.

The image processing device 810 described here may be implemented in a computer or a server device installed on the ground, for example.

The drone 805 is an unmanned aerial vehicle that flies using rotor blades or the like. The drone 805 according to the second embodiment of the present disclosure is not specifically limited, and an arbitrary drone may be used, as long as it is equipped with a camera capable of acquiring a high-resolution video (a video acquisition unit 820), a computing function capable of executing the image processing according to the embodiments of the present disclosure (the tracking processing unit 203), and a wireless communication function (not shown) for communicating with the image processing device 810.

As illustrated in FIG. 8, the drone 805 includes the tracking processing unit 203, a moving body control unit 815, and the video acquisition unit 820.

The tracking processing unit 203 is substantially similar to the tracking processing unit 203 according to the first embodiment, so that the descriptions thereof will be omitted here.

The moving body control unit 815 is a functional unit for controlling the movement and functions of the drone 805, and for example, may be implemented as a microcomputer or a System on a Chip (SoC) mounted on the drone 805. The moving body control unit 815 may control the movement of the drone 805 based on commands received from a moving body management unit 803 of the image processing device 810, for example.

The video acquisition unit 820 is a camera capable of acquiring a high-resolution video, and it is substantially similar to the video acquisition device 201 according to the first embodiment, so that the descriptions thereof will be omitted here.

The image processing device 810 according to the second embodiment differs from the image processing device 210 according to the first embodiment in that the tracking processing unit 203 is mounted on the drone 805 and that it is equipped with the moving body management unit 803.

The moving body management unit 803 is a functional unit for generating instructions for controlling the movement of the drone 805 and transmitting these instructions to the drone 805. The moving body management unit 803 may generate a following command for following the detected target object based on the object detection result of the object detection processing unit 202, for example, and transmit the following command to the drone 805.

Next, a flow of operation of the image processing system 800 according to the second embodiment of the present disclosure will be described with reference to FIG. 9.

FIG. 9 is a flowchart illustrating a flow 900 of operation of the image processing system 800 according to the second embodiment of the present disclosure.

At first, in step S905, the video acquisition unit 820 of the drone 805 acquires a specific image frame (hereinafter referred to as “first image”) from a high-resolution video data, and transmits the acquired first image through a high-speed, high-capacity wireless communication to the image processing device 810.

Next, in step S910, the object detection processing unit 202 of the image processing device 810 executes the above-described object detection process (for example, the object detection process 300 illustrated in FIG. 3) with respect to the first image received from the drone 805, to thereby specify the target object in the first image and generate a first object detection result at least indicating the position of the target object in the image. Thereafter, the object detection processing unit 202 transmits the generated first object detection result to the moving body management unit 803.

Next, in step S915, the moving body management unit 803 of the image processing device 810 creates a following command for following the detected target object based on the first object detection result received from the object detection processing unit 202. The term following command used in the present description refers to information requesting the drone 805 to follow the specified target object that was detected.

Thereafter, the moving body management unit 803 transmits the created following command to the drone 805.

Next, in step S920, the moving body control unit 815 may control the movement of the drone 805 or the image capturing conditions (such as pan, tilt, and zoom) of the video acquisition unit 820 for capturing the target object clearly and near the center of the image based on the following command received from the moving body management unit 803 of the image processing device 810.

Next, in step S925, the tracking processing unit 203 executes the tracking process mentioned above (for example, the tracking process 400 illustrated in FIG. 4). More specifically, the tracking processing unit 203 acquires a target region image for the target object specified in the following command. Here, the tracking processing unit 203 may perform cropping of the target region image from the first image acquired in step S905, or may perform cropping of the target region image from a new image acquired by the video acquisition unit 820.

Thereafter, the tracking processing unit 203 executes a resizing process for converting the target region image into a predetermined size to generate a resized image, and thereafter, executes a predetermined object detection process with respect to the resized image, to thereby generate a second object detection result indicating at least a position of the target object in the image.

The resized image described here is an image having a lower resolution compared to the first image, such that compared to the object detection processing performed for the first image by the object detection processing unit 202 of the image processing device 810, the object detection processing performed with respect to the target object image by the tracking processing unit 203 of the drone 805 has a lower processing load and may be performed at high speed. Thereby, the computational load of the processing performed on the drone 805 may be suppressed and the power consumption of the drone 805 may be suppressed.

Next, in step S930, the moving body control unit 815 controls the drone 805 to follow the target object based on the second object detection result generated in step S925. Thereby, the drone 805 follows the target object while capturing the image of the target object, and transmits the acquired video data (for example, the second image) to the image processing device 810.

Thereafter, the image processing device 810 executes the above-described integration processing and the display processing, and executes the processing of step S910 and thereafter with respect to a newly acquired second image.

According to the image processing system of the second embodiment of the present disclosure, the object detection processing performed with respect to the high-resolution image is performed by the ground-side image processing device, and the tracking processing is performed with respect to an image having a lower resolution on the drone side, such that high-speed tracking processing of a target object in wide area monitoring can be enabled while suppressing the processing load and power consumption of the drone.

As described, according to the image processing technique of the embodiment of the present disclosure, only the object detection process is executed with respect to the high-resolution image, and the tracking process performed thereafter is executed with respect to an image having a lower resolution, such that compared to a case where both the object detection process and the tracking process are executed with respect to the high-resolution image, the processing speed may be enhanced while maintaining the precision of the tracking process and suppressing the processing load.

Thereby, even in a case where real-time detection and tracking is required, such as when the detection target is moving at high speed, high precision detection results may be provided in real time.

Further, by suppressing the processing load, the image processing according to the embodiments of the present disclosure may be implemented on a drone or other devices having limited power.

Embodiments of the present invention have been described above, but the present invention is not limited to the embodiments described above, and various modifications are enabled within the scope of the present invention.

Moreover, naturally, the functional units such as the video acquisition unit, the object detection processing unit, the tracking processing unit, and the integration processing unit according to the present invention may be equipped with functions other than those described above.

### DESCRIPTION OF THE REFERENCE NUMERAL

200, 800: image processing system, 201: video acquisition device, 202: object detection processing unit, 203: tracking processing unit, 204: integration processing unit, 205: display control unit, 206: communication network, 210, 810: image processing device, 803: moving body management unit, 805: drone, 815: moving body control unit, 820: image acquisition unit

1-8. (canceled)

9. An image processing device comprising:
a video acquisition unit configured to acquire a first image;
an object detection processing unit configured to execute a predetermined object detection process with respect to the first image, specify a target object in the first image, and generate a first object detection result indicating a position of the target object in the first image;
a tracking processing unit configured to acquire a target region image including the target object based on the first object detection result, generate a resized image by executing a resizing process of converting the target region image to a predetermined size, execute a predetermined object detection process with respect to the resized image, and generate a second object detection result indicating a position of the target object in the resized image; and
an integration processing unit configured to generate a final object detection result by integrating the first object detection result and the second object detection result,
wherein
the tracking processing unit is configured to determine an image capturing condition to capture the target region image including the target object based on the first object detection result, and transmit the image capturing condition that was determined to the video acquisition unit, and
the video acquisition unit is configured to receive the image capturing condition, perform image capturing based on the image capturing condition that was received to acquire the target region image, and transmit the target region image that was acquired to the tracking processing unit.

10. The image processing device according to claim 9,
wherein the tracking processing unit is configured to extract the target region image from the first image based on the first object detection result.

11. The image processing device according to claim 10, wherein
the first image is an image that satisfies a first pixel count criterion, and
the resized image is an image that is below a second pixel count criterion.

12. An image processing device comprising:
a video acquisition unit configured to acquire a first image;
an object detection processing unit configured to execute a predetermined object detection processing with respect to the first image, specify a target object in the first image, and generate a first object detection result indicating a position of the target object in the first image;
a tracking processing unit configured to acquire a target region image including the target object based on the first object detection result, generate a resized image by executing a resizing process of converting the target region image to a predetermined size, execute a predetermined object detection process with respect to the resized image, and generate a second object detection result indicating a position of the target object in the resized image; and
an integration processing unit configured to generate a final object detection result by integrating the first object detection result and the second object detection result,
wherein the integration processing unit is configured to
overlap the first object detection result and the second object detection result, and
integrate the first object detection result and the second object detection result based on an overlap degree of the target object indicated in the first object detection result and the target object indicated in the second object detection result, to thereby generate the final object detection result.

13. The image processing device according to claim 12, wherein the tracking processing unit is configured to extract the target region image from the first image based on the first object detection result.

14. The image processing device according to claim 13, wherein
the first image is an image that satisfies a first pixel count criterion, and
the resized image is an image that is below a second pixel count criterion.

15. An image processing system comprising:
a moving body on which a video acquisition unit device configured to acquire an image is installed; and
an image processing device,
wherein
the moving body and the image processing device are connected through a communication network,
the image processing device includes
an object detection processing unit configured to execute a predetermined object detection process with respect to a first image received from the video acquisition unit device, specify a target object in the first image, and generate a first object detection result indicating a position of the target object in the first image; and
a moving body instruction unit configured to create a following command for tracking the target object based on the first object detection result, and transmit the following command that was created to the moving body, and the moving body includes
a tracking processing unit configured to acquire a target region image including the target object based on the following command, generate a resized image by executing a resizing process of converting the target region image to a predetermined size, execute a predetermined object detection process with respect to the resized image, and generate a second object detection result indicating a position of the target object in the resized image;
a moving body control unit configured to control the moving body to follow the target object based on the second object detection result; and
a video acquisition unit configured to acquire a second image indicating the target object while following the target object, and transmit the second image to the image processing device,
the tracking processing unit is configured to determine an image capturing condition to capture the target region image including the target object based on the first object detection result, and transmit the image capturing condition that was determined to the video acquisition unit, and
the video acquisition unit is configured to receive the image capturing condition, perform image capturing based on the image capturing condition that was received to acquire the target region image, and transmit the target region image that was acquired to the tracking processing unit.

16. The image processing system according to claim 15,
wherein the first image is an image that satisfies a first pixel count criterion, and
wherein the resized image is an image that is below a second pixel count criterion.
